(19) United States
(12) Patent Application Publication
(10) Pub. No.: US 2012/0105283 A1
(43) Pub. Date: May 3, 2012

(54) DISTANCE MEASURING DEVICE FOR GOLF

(75) Inventors: Scott Nyhart, Shawnee, KS (US); Brian Marquess, Olathe, KS (US); Jordan Vermillion, Overland Park, KS (US)

(73) Assignee: Bushnell Inc., Overland Park, KS (US)

(21) Appl. No.: 12/917,134

(22) Filed: Nov. 1, 2010

(51) Int. Cl. G01S 19/48; G01S 19/19; G01C 3/08

(52) U.S. Cl. 342/357.31; 356/5.01; 342/357.57

(57) ABSTRACT

A distance measuring device for determining distances to objects on a golf course comprises a laser rangefinder; a satellite navigation receiver; and a portable handheld housing for housing both the laser rangefinder and the satellite navigation receiver. The housing has opposed left and right sidewalls, opposed top and bottom walls, and opposed front and rear walls, with all of the walls being sized and configured to permit a user to hold the device with one hand. A display for displaying distance information from the satellite navigation receiver is positioned in one of the sidewalls of the housing and an eyepiece of the laser rangefinder is positioned in the front wall of the housing. This permits a user to hold the device with one hand, look through the eyepiece to operate the laser rangefinder, and then simply twist his or her hand to view satellite navigation information on the display without releasing or re-gripping the device.

### BACKGROUND

Golfers often desire to know the distance to greens, flag sticks, bunkers, or other spots or areas on golf courses. The two most popular distance measuring devices for golf use are laser rangefinders and GPS devices.

Laser rangefinders transmit laser pulses at a target and receive reflected pulses therefrom. An internal clock monitors the time difference between the transmitted and received pulses, halves the time difference and multiplies it by the speed of light to thereby derive a distance from the rangefinder to the target. Laser rangefinders are highly accurate, but they require a line of sight to a target and are therefore not as useful when objects such as trees, hills, etc. block a player's view of a target.

GPS devices acquire satellite signals from orbiting GPS satellites, calculate their current position based on these signals, and then calculate distances between the device and pre-mapped targets. GPS devices do not have to be aimed and therefore do not require a line of sight to a target, but they are less accurate than laser rangefinders and are therefore not as useful when a golfer wants to know a precise distance to a target. Moreover, GPS devices only show the distance to selected, pre-mapped targets such as quadrants of greens, bunkers, etc. and are therefore not as useful when a golfer wants to know a distance to a non-mapped target.

Because laser rangefinders and GPS devices both have advantages and disadvantages, many golfers carry one of each. However, carrying two devices while golfing is cumbersome and often slows a player's pace of play as he or she decides which device is the most appropriate for a particular situation.

### SUMMARY

The present invention solves the above-described problems and provides a distinct advance in the art of distance measuring devices for golf use by providing an integrated distance measuring device for golf that combines the features of both a laser rangefinder and a GPS device.

An embodiment of the device broadly comprises a laser rangefinder; a satellite navigation receiver; and a handheld housing for housing both the laser rangefinder and the satellite navigation receiver. The device may also comprise a single power supply for powering both the laser rangefinder and the satellite navigation receiver.

An embodiment of the housing has opposed left and right sidewalls, opposed top and bottom walls, and opposed front and rear walls. All of the walls are sized and configured to permit a user to hold the device with one hand while using both the laser rangefinder and satellite navigation receiver.

The device may further comprise a display for displaying distance information from the satellite navigation receiver. The display is advantageously positioned in one of the sidewalls of the housing, and the eyepiece of the laser rangefinder is positioned in the front wall of the housing. This permits a user to hold the device with one hand, look through the eyepiece to operate the laser rangefinder, and then simply twist his or her hand to view GPS information on the display.

The sidewall in which the display is mounted further includes a lower, inwardly-projecting ledge. A plurality of user inputs are positioned on the ledge for controlling functions of the satellite navigation receiver and the display. The positioning of these inputs permits a user to easily access and operate them with the thumb of his or her free hand while still holding the device with the opposite hand.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a distance measuring device constructed in accordance with embodiments of the present invention.

FIG. 2 is a side elevational view of the device of FIG. 1.

FIG. 3 is a perspective view showing a golfer using the device to range a target with the laser rangefinder.

FIG. 4 is another perspective view showing the golfer using the device to determine a distance to an object with the satellite navigation receiver.

FIG. 5 is a block diagram depicting the primary components of the device.

FIG. 6 is a block diagram depicting the primary components of the laser rangefinder portion of the device.

FIG. 7 is another block diagram depicting the primary components of the satellite navigation receiver portion of the device.

FIG. 8 is a schematic representation of a global navigation satellite system that may provide signals to the satellite navigation receiver portion of the device.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

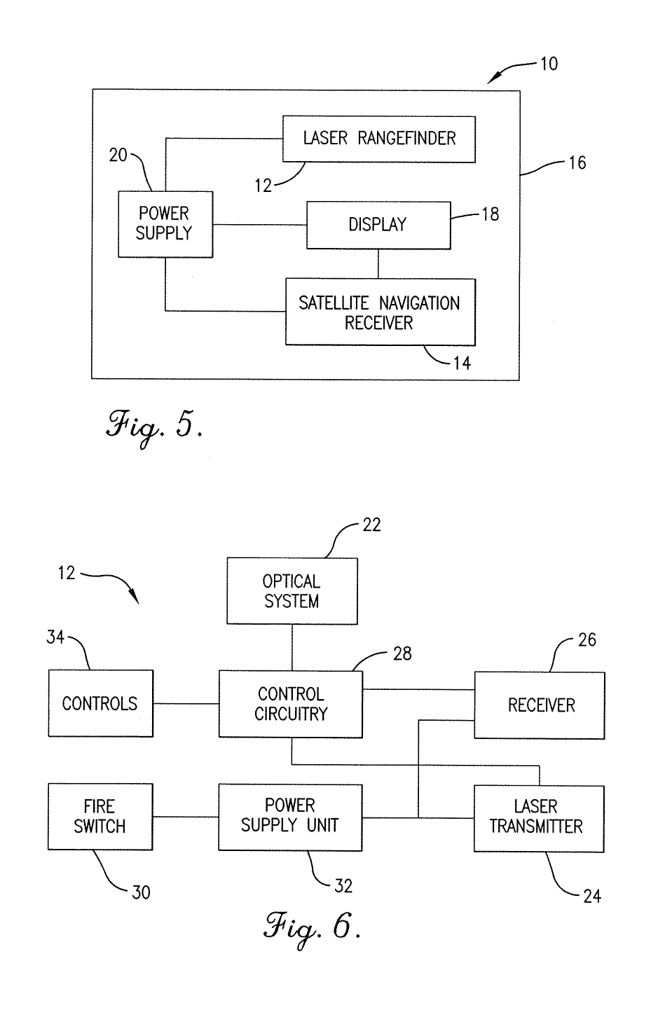

Turning now to the drawing figures, a distance-measuring device 10 constructed in accordance with various embodiments of the invention is illustrated. The device 10 is constructed and configured for determining distances to objects on golf courses such as flag sticks, greens, bunkers, hazards, etc. As best shown in FIG. 5, the device 10 broadly includes a laser rangefinder 12; a satellite navigation receiver 14; and a portable handheld housing 16 for housing the laser rangefinder and the satellite navigation receiver. The device may also comprise a display 18 and a single power supply 20 for powering the laser rangefinder, satellite navigation receiver, and display.

Turning now to FIG. 6, an embodiment of the laser rangefinder 12 includes an optical system 22 for viewing a target on a golf course; a laser transmitter 24 for transmitting a laser signal toward the target; a receiver 26 for receiving reflections of the signal reflected from the target; and control circuitry 28 for determining a distance to the target. The laser rangefinder may also comprise a fire switch or power button 30 for triggering the laser transmitter 24, a power supply unit 32 coupled with the power supply 20, and one or more user controls 34. Many of the components of the laser rangefinder are conventional and are therefore not described in detail herein.

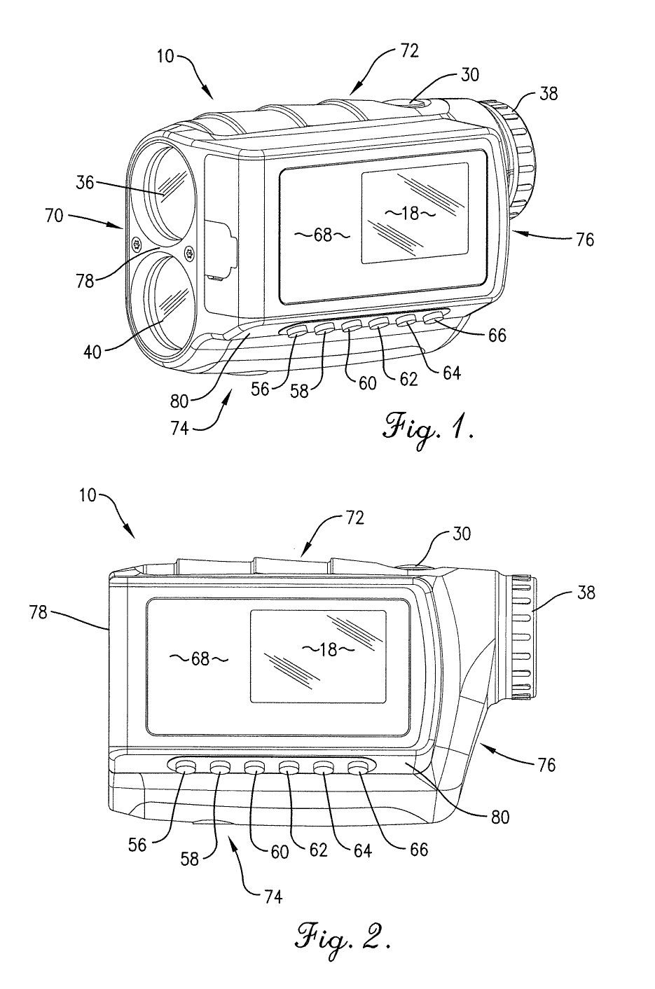

As best shown in FIGS. 1 and 2, an embodiment of the optical system 22 includes an objective lens 36, an eyepiece 38 with diopter adjustment and 5× or 7× magnification, a laser receiver lens 40, and an in-view display. The in-view display may be a liquid crystal display (LCD) or any other type of display and incorporates illuminated indicators for an aiming circle or reticle, distance measurements, and mode indicators.

The laser transmitter 24 includes an eye-safe FDA Class 1 and LE Class 3A laser emitting diode for directing a laser signal out of the objective lens 36 and toward a target. The laser transmitter 36 also supplies a “fire” signal to the control circuitry 28. Details of an exemplary laser transmitter are disclosed in more detail in U.S. Pat. Nos. 5,612,779, 5,652,651, and 5,926,259, all of which are incorporated into the present application in their entireties by reference.

The receiver 26 includes a laser receiving diode that receives reflections of the laser signal emitted from the laser emitting diode as they are reflected from an object back through a laser receiver lens. Details of an exemplary receiver are disclosed in more detail in the above-referenced U.S. Pat. Nos. 5,612,779, 5,652,651, and 5,926,259.

The control circuitry 28 is operatively coupled with the laser transmitter 24 and the receiver 26 and is configured to determine a distance to a target based on the time of flight of the laser signal. In one embodiment, the control circuitry includes a microprocessor and application-specific integrated circuit (ASIC); a precision timing circuit; an oscillator; and an automatic noise threshold circuit. The control circuitry 28 may also include or be coupled with a mode switch by means of which an operator can change the operating mode and functional operation of the laser rangefinder.

The control circuitry 28, once enabled via the fire switch 30, is programmed to cause the laser generator to fire a series of laser light pulses, each with a duration of approximately 5 to 100 nanoseconds. Once the laser pulses are reflected off of a target, a portion of each pulse is returned to the receiver 26. Detection of a received pulse triggers the precision timing circuit and automatic noise threshold circuit, each of which is described in detail in the above-referenced U.S. Pat. Nos. 5,612,779, 5,652,651, and 5,926,259. If sufficient pulses are received to perform a reliable range calculation, the calculation locks onto a calculated range and displays the calculated range on the in-view display. Additional operational details of the laser rangefinder are discussed below.

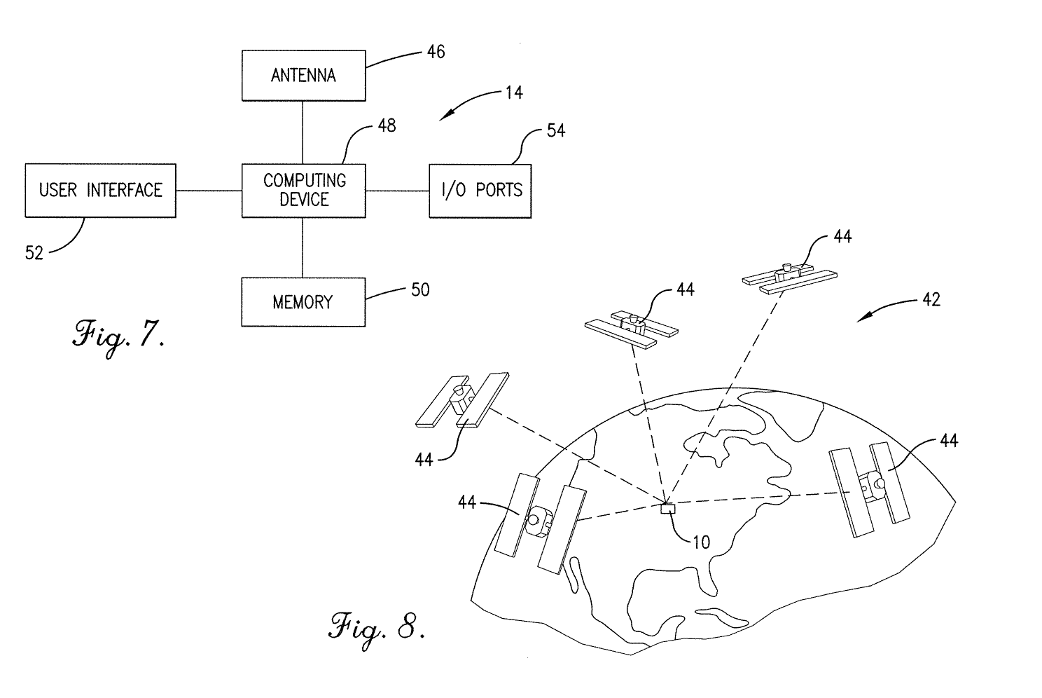

The satellite navigation receiver 14 component of the device 10 will now be described with reference to FIGS. 7 and 8. The satellite navigation receiver 14 may work with any global navigation satellite system (GNSS) such as the global positioning system (GPS) primarily used in the United States, the GLONASS system primarily used in the Soviet Union, or the Galileo system primarily used in Europe. FIG. 8 schematically depicts a GNSS 42 having a plurality of satellites 44 in orbit about the Earth. A satellite navigation receiver device such as the device 10 of the present invention receives satellite signals from the satellites. The satellite signals incorporate time data from an extremely accurate atomic clock and a data stream that identifies the satellite. The device 10 must acquire satellite signals from at least three satellites in order to calculate its two-dimensional position by triangulation.

Turning now to FIG. 7, an embodiment of the satellite navigation receiver 14 broadly includes an antenna 46, a computing device 48, memory 50, a user interface 52, and input/output (I/O) ports 54. Many of the components of the satellite navigation receiver 14 are conventional and are therefore not described in detail herein.

The antenna 46 may be a patch antenna, linear antenna, or any other device operable to receive signals from the satellites 44. The antenna may be mounted in or on the housing 16 and is electrically connected to the computing device 48.

The computing device 48 may include one or more processors, controllers, or other devices and is programmed to calculate location and other geographic information as a function of the received satellite signals. In one embodiment, the computing device is part of an application specific integrated circuit (ASIC) similar to that found in commercially-available portable GPS receivers.

The memory 50 may be RAM, ROM, Flash, magnetic, optical, USB memory devices, and/or other conventional memory elements. The memory may store various data associated with operation of the device 10. For example, the memory may store cartographic data showing the tee boxes, fairways, greens, hazards, etc. for selected golf courses or for all known golf courses. The cartographic information is preferably pre-loaded in the memory but may be downloaded to the device via the I/O ports 54.

The memory 50 may also store a map-matching search engine that searches through the database of cartographic information to find known golf courses or golf course holes that match the device's current location. The search engine or other programs executed by the device may also perform calculations related to the cartographic information.

The user interface 52 permits a golfer to operate features of the satellite navigation component 14 and may comprise one or more functionable inputs such as buttons, switches, scroll wheels, a touch screen display, touchpads, trackballs, styluses, or combinations thereof. In the embodiment shown in FIGS. 1 and 2, the user interface 52 includes a number of buttons, including a power button 56 for turning the device on and off, a screen button 58 for displaying distances to additional points of interest, a scroll-up button 60 for scrolling the display up or for selecting another hole on a golf course, a scroll-down button 62 for scrolling the display down or for selecting a previous hole on a golf course, an OK/SHOT button 64 for selecting a highlighted option or activating a shot distance, and an ESC/MENU button 66 for cancelling a current control operation or returning to a previous step, screen, or menu.

The I/O ports 54 permit data and other information to be transferred to and from the device. The I/O ports may include a USB port or mini USB port for coupling with a USB cable connected to another computing device such as a personal computer. Navigational software, cartographic maps and other data and information may be loaded in the device via the I/O ports.

The display 18 presents distance information calculated by the satellite navigation receiver such as a distance from the current location of the device to a flag stick or other target. The display may comprise conventional black and white, monochrome, or color display elements including, but not limited to, Liquid Crystal Display (LCD), Thin Film Transistor (TFT) LCD, Polymer Light Emitting Diode (PLED), Organic Light Emitting Diode (OLED) and/or plasma display devices. The display may incorporate touch-screen electronics to enable a golfer to interact with it by touching or pointing at display areas to provide information to the device.

The power supply 20 provides electrical power to the components of the laser rangefinder 12 and satellite navigation receiver 14. The power supply 20 may comprise conventional power supply elements, such as batteries, battery packs, etc. The power supply may also comprise power conduits, connectors, and receptacles operable to receive batteries, battery connectors, or power cables. For example, the power supply may include both a battery to enable portable operation and a power input for receiving power from an external source. In one embodiment, the power source is an internal rechargeable lithium-ion battery that may be charged via the USB or mini USB port described above. The power supply includes or is coupled with the high voltage (HV) power supply unit 32 that supplies operating power to the laser transmitter 24 of the laser rangefinder.

The housing 16 is handheld or otherwise portable to facilitate easy use while golfing. The housing 16 may be constructed from a suitable lightweight and impact-resistant material such as plastic, nylon, aluminum, or any combination thereof and may include gaskets or seals to make it substantially waterproof or resistant.

An embodiment of the housing 16 illustrated in FIGS. 1 and 2 has opposed left and right sidewalls 68, 70, opposed top and bottom walls 72, 74, and opposed front and rear walls 76, 78. All of the walls are sized and configured to permit a user to hold the device 10 with one hand. The top and bottom walls 72, 74 may be curved and covered with rubber grips to facilitate gripping of the device. The left sidewall 68 includes a lower, inwardly-projecting ledge 80. The user interface 52 of the satellite navigation receiver, such as the buttons 56-66, are positioned on the ledge. In one embodiment, the housing is approximately 4.3″ long measured between the front and rear walls, approximately 2.8″ tall measured between the top and bottom walls, and 1.8″ wide measured between the left and right sidewalls. The entire device only weighs approximately 8.5 ounces.

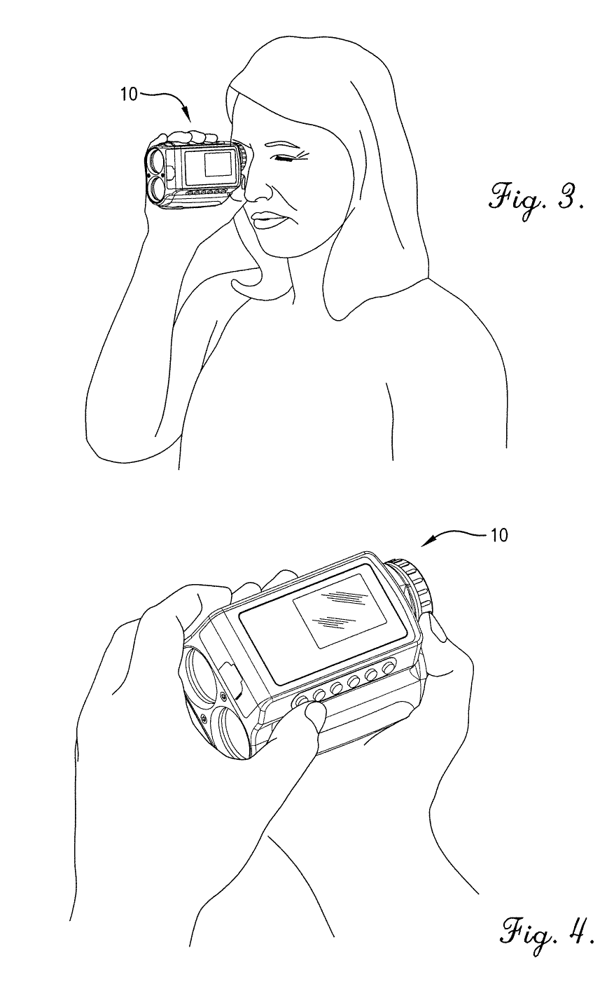

As shown in FIGS. 1-4, the display 18 is advantageously positioned in the left sidewall 68 of the housing, and the eyepiece 38 is positioned in the front wall 76 of the housing. This permits a user to hold the device 10 with his or her right hand and look through the eyepiece 38 to operate the laser rangefinder 12 as shown in FIG. 3. After acquiring a distance reading with the laser rangefinder 12, the user may then simply twist his or her hand to view GPS information on the display 18 without releasing or re-gripping the device as shown in FIG. 4.

Similarly, the positioning of the inputs 56-66 on the ledge 80 permits a golfer to easily access and operate them with the thumb of his or her left hand while still holding the device with the right hand as depicted in FIG. 4. In an alternative embodiment of the invention, the display 18 and user inputs 56-66 may be positioned on the right sidewall so that a left-handed user can hold the device with his or her left hand and operate the user inputs with his or her right thumb.

The above-described device 10 may be used to determine a distance to a target on a golf course with the laser rangefinder 12, the satellite navigation receiver 14, or both. To range a target with the laser rangefinder 12, a golfer looks through the eyepiece 38 as depicted in FIG. 3, aims the device at the target, and views an optically magnified image of the target in the field of view of the rangefinder. The golfer may then press the fire switch 30 once to activate the in-view display. This places an aiming circle or reticle in the center of the field of view.

Once the aiming circle is positioned on the target, the golfer may engage and hold the fire switch 30, causing the laser transmitter 24 to emit a series of laser pulses, as described above. Crosshairs are displayed on the in-view display surrounding the aiming circle to indicate that the laser is transmitting. Once the laser pulses are reflected off of the target, a portion of each pulse is returned to the receiver 26. Detection of a received pulse triggers the precision timing section and automatic noise threshold section of the control circuitry 28. If sufficient pulses are received to perform a reliable range calculation, the control circuitry 28 locks onto a calculated range and displays the calculated range on the in-view display. Once a range has been acquired, the golfer may release the fire switch 30 to de-activate the laser 24. This will cause the reticle or crosshairs to disappear from the in-view display, but the display will remain active and display the last distance measurement for a pre-determined amount of time such as 30 seconds.

The golfer may also use the satellite navigation receiver 14 to determine a distance to a target. For example, after determining the precise distance to a flag stick with the laser rangefinder 12, the golfer may wish to determine the approximate distance to the front, center, or back of the green with the satellite navigation receiver. Or, while playing a course that does not allow carts to leave the cart path, the golfer may wish to use the satellite navigation receiver to determine the approximate distance to a target to select a club or clubs to carry to the golfer's ball. Or, when the golfer does not have a line-of-sight to the flag stick or other target, the or she may use the satellite navigation receiver exclusively.

To use the satellite navigation receiver 14 (after it has been activated by the button 56), the golfer merely twists his or her hand as described above and as illustrated in FIG. 4 to view location and distance information acquired by the satellite navigation receiver on the display. As the golfer is holding the device with his or her right hand and viewing the information on the display, the golfer may operate the user inputs with the thumb of his or her right hand. As the golfer continues to play, the satellite navigation receiver auto-advances to the next hole.

Although the invention has been described with reference to the exemplary embodiments illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A distance measuring device for determining distances to objects on a golf course, the device comprising:
a laser rangefinder comprising:
a laser transmitter for transmitting a laser signal toward an object on the golf course,
a receiver for receiving reflections of the signal reflected from the object, and control circuitry for determining a distance to the object based on a time of flight of at least a portion of the laser signal from its transmission from the laser transmitter to its reflection back to the receiver;
a satellite navigation receiver operable to receive navigation signals from a plurality of navigation satellites and to determine current locations of the device as a function of the satellite signals; and
a portable handheld housing for housing both the laser rangefinder and the satellite navigation receiver.

2. The distance measuring device as set forth in claim 1, further comprising a single power supply for powering both the laser rangefinder and the satellite navigation receiver.

3. The distance measuring device as set forth in claim 2, wherein the single power supply comprises a battery or electrical contacts or terminals for connecting to a battery.

4. The distance measuring device as set forth in claim 1, wherein the housing has opposed left and right sidewalls, opposed top and bottom walls, and opposed front and rear walls, all of the walls being sized and configured to permit a user to hold the device with one hand, with the user's palm placed against the left or right sidewall and the user's fingers wrapped substantially over the top wall.

5. The distance measuring device as set forth in claim 4, further comprising a display for displaying location information from the satellite navigation receiver, the display being positioned in the sidewall opposite to the sidewall engaged by the user's palm.

6. The distance measuring device as set forth in claim 5, wherein the sidewall on which the display is mounted includes a lower inwardly extending ledge.

7. The distance measuring device as set forth in claim 6, further comprising a plurality of user inputs positioned on the ledge for controlling functions of the satellite navigation receiver and the display.

8. The distance measuring device as set forth in claim 4, further comprising a fire button positioned on the top wall for activating the laser transmitter.

9. A distance measuring device for determining distances to objects on a golf course, the device comprising:
a laser rangefinder comprising:
a laser transmitter for transmitting a laser signal toward an object on the golf course,
a receiver for receiving reflections of the signal reflected from the object, and control circuitry for determining a distance to the object based on a time of flight of at least a portion of the laser signal from its transmission from the laser transmitter to its reflection back to the receiver;
a satellite navigation receiver operable to receive navigation signals from a plurality of navigation satellites and to determine current locations of the device as a function of the satellite signals;
a portable handheld housing for housing both the laser rangefinder and the satellite navigation receiver, the housing having opposed left and right sidewalls, opposed top and bottom walls, and opposed front and rear walls, all of the walls being sized and configured to permit a user to hold the device with one hand, with the user's palm placed against the left or right sidewall and the user's fingers wrapped substantially over the top wall; and
a display for displaying location information from the satellite navigation receiver, the display being positioned in the sidewall opposite to the sidewall engaged by the user's palm.

10. The distance measuring device as set forth in claim 9, further comprising a single power supply for powering both the laser rangefinder and the satellite navigation receiver.

11. The distance measuring device as set forth in claim 10, wherein the single power supply comprises a battery or electrical contacts or terminals for connecting to a battery.

12. The distance measuring device as set forth in claim 9, wherein the sidewall on which the display is mounted includes a lower inwardly extending ledge.

13. The distance measuring device as set forth in claim 12, further comprising a plurality of user inputs positioned on the ledge for controlling functions of the satellite navigation receiver and the display.

14. The distance measuring device as set forth in claim 9, further comprising a fire button positioned on the top wall for activating the laser transmitter.

15. A distance measuring device for determining distances to objects on a golf course, the device comprising:
a laser rangefinder comprising:
a laser transmitter for transmitting a laser signal toward an object on the golf course,
a receiver for receiving reflections of the signal reflected from the object, and
control circuitry for determining a distance to the object;
a satellite navigation receiver operable to receive navigation signals from a plurality of navigation satellites and to determine current locations of the device as a function of the satellite signals;
a single power supply for powering both the laser rangefinder and the satellite navigation receiver;
a handheld housing for housing the laser rangefinder, the satellite navigation receiver, and the power supply, the housing having opposed left and right sidewalls, opposed top and bottom walls, and opposed front and rear walls, all of the walls being sized and configured to permit a user to hold the device with the user's right hand, with the user's right palm placed against the right sidewall and the user's fingers wrapped substantially over the top wall; and
a display for displaying location information from the satellite navigation receiver, the display being positioned in the left sidewall.

16. The distance measuring device as set forth in claim 15, wherein the single power supply comprises a battery or electrical contacts or terminals for connecting to a battery.

17. The distance measuring device as set forth in claim 15, wherein the left sidewall includes a lower inwardly extending ledge.

18. The distance measuring device as set forth in claim 17, further comprising a plurality of user inputs positioned on the ledge for controlling functions of the satellite navigation receiver and the display.
